(19) United States
(12) Patent Application Publication
(10) Pub. No.: US 2024/0048727 A1
(43) Pub. Date: Feb. 8, 2024

(54) METHOD AND SYSTEM OF LOW LATENCY VIDEO CODING WITH INTERACTIVE APPLICATIONS

(71) Applicant: Intel Corporation, Santa Clara, CA (US)

(72) Inventors: Jason Tanner, Folsom, CA (US); Stanley Baran, Chandler, AZ (US); Kristoffer Fleming, Chandler, AZ (US); Chia-Hung S. Kuo, Folsom, CA (US); Sankar Radhakrishnan, Bothell, WA (US); Venkateshan Udhayan, Portland, OR (US)

(73) Assignee: Intel Corporation, Santa Clara, CA (US)

(21) Appl. No.: 18/488,667

(22) Filed: Oct. 17, 2023

(51) Int. Cl. H04N 19/162; H04N 19/105; H04N 19/172; H04N 19/46

(52) U.S. Cl. CPC H04N 19/162; H04N 19/105; H04N 19/172; H04N 19/46

(57) ABSTRACT

A computer-implemented method of video coding comprises receiving at least one frame of a video sequence of an interactive application interface associated with at least one asset displayable on the interface in response to a user action related to the interface. The method includes encoding the at least one frame. The method also includes transmitting the at least one asset and the encoded at least one frame to a remote device. The transmitting operation refers to performing the transmitting regardless of whether a request to display the at least one asset exists. The asset can be a non-persistent asset on the frame only while a user performs a continuous action or maintains a cursor at a specific place on the interface. The asset also can be a persistent asset on the frame in response to a first action and is removed from the display in response to a second action.

### BACKGROUND

A number of remote screen mirroring programs are known where one computer running an interactive application transmits an interface screen of that application to a remote display for viewing. The remote display may be on a wireless wide area computer network, such as the internet, or a wireless personal area network. For example, a word processor may be running on a laptop and transmitting the view of the word processor to a large monitor for a multi-display desk area, other computing device such as another laptop, or a large presentation screen. This also may occur when a user is working remotely and sharing their screen with multiple other remote viewers in a video conference for example. When the user is viewing the remote display while using the application, significant latency still occurs from the time a user acts, such as by clicking a mouse to open a menu on the screen, from a time the menu actually is open and visible on the remote screen. This latency can be very annoying for the users and results in a bad user experience.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a schematic diagram of an image processing system according to at least one of the implementations herein;

FIG. 2 is a schematic diagram of interface of an interactive application according to at least one of the implementations herein;

FIG. 3 is a flow chart of an example method of image processing related to a transmitting side according to at least one of the implementations herein;

FIG. 4 is a graph of typical bandwidth capacity use over multiple video frames for an interactive application according to at least one of the implementations herein;

FIG. 5 is another flow chart of an example method of image processing related to a receiving side according to at least one of the implementations herein;

FIG. 6 is a detailed flow chart of an example method of image processing related to a transmitting side according to at least one of the implementations herein;

FIG. 7 is a flow chart of an example method of image processing adding more details to the flow chart of FIG. 6 according to at least one of the implementations herein;

FIG. 8 is a flow chart of an example method of image processing adding yet more details to the flow chart of FIG. 6 according to at least one of the implementations herein;

FIG. 9 is a flow chart of an example method of image processing adding more details for a receiving side according to at least one of the implementations herein;

FIG. 10 is an illustrative diagram of an example system;

FIG. 11 is an illustrative diagram of another example system; and

FIG. 12 illustrates an example device, all arranged in accordance with at least some of the implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein also may be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various commercial or consumer computing devices and/or electronic devices such as servers, computers, laptops, desktops, set top boxes, smart phones, tablets, televisions, mobile gaming devices, gaming engines, game consoles, virtual, augmented, or modified reality headsets, and so forth, may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Methods, devices, apparatuses, systems, computing platforms, and articles described herein are related to low latency video coding with interactive applications.

Wireless display technology is used to provide multi-device experiences (MDEs) including attempts to provide seamless display sharing for hybrid workspaces, such as during video conferences where screen sharing is a valuable feature. The screen sharing can increase efficiency by focusing on the sharing of productivity workloads. For example, when a user is sharing or mirroring their screen in a video conference, an interface of a typical workplace interactive application, such as a word processor, spread sheet, or slide presentation application, can be shown to other users on the conference to demonstrate, teach, or discuss a certain topic with much greater clarity with these visual tools. The interaction of the user with the interface, however, still may use control from an input device, whether a mouse or other object to place a cursor at a location on the interface, or a keyboard to type communications or select commands on the interface, and so forth. Both the transmitting device sharing the interface and the receiving devices displaying the interface may be used with many different productivity scenarios and that span multiple devices such as smartphone, tablet, laptop, desktop, and many others.

Also as mentioned, from the time of the interaction (the time a user clicks on the mouse to open a menu for example) to the time of display of the menu on the receiving or remote device can have a detectable latency that often occurs and that reduces the quality of the user experience. This latency has found to be 50-100 ms.

The conventional techniques to reduce latency include transmitting separate images or objects of the interface to the receiving devices so that the separate images can be overlaid or composited with the streaming video at the receiving device in order to reduce the computational load at the encoder and by simplifying the frames that are being encoded. One such conventional method includes improving interactivity with a pointer or mouse cursor. The video stream of encoded frames of an interface and the image of the mouse cursor are treated as two separate elements, where the mouse cursor is a persistent object that is always present with a simple overlay. Thus, the mouse cursor is constantly overlaid or composited onto the video frames at the receiving device. This is accomplished by transmitting the image of the mouse cursor to the receiving devices on a conference or mirroring session. Thereafter, the location of the mouse cursor is transmitted to the receiving devices to update the position of the cursor. Captioning can be treated in the same way. These techniques still result in significant latency during a screen sharing or mirroring session because an interactive application typically has many more overlay images than just the mouse (and captioning) that can add to the complexity of the images at the encoder. This includes temporary objects or images (or assets as described below) and that may be present on a very small number of video frames.

Otherwise, permanent objects that are always present and do not move on an interactive application interface, such as a border of a word processor also may be transmitted separately from the video and composited as an overlay onto the coded changing video stream frames rather than being encoded. Other known techniques will transmit objects, such as a mouse click menu of available commands, once those objects are requested by the user (in a deterministic manner). These techniques still result in significant latency because the time to request a particular object and then transmit that object on an as needed basis still causes significant delay. The delay may be worse when the object is transmitted during a time of busy traffic where the video consumes a large part of the available bandwidth.

To resolve these issues, the disclosed system and method transmits non-persistent and/or persistent assets to a remote device to display an interactive application interface, which may be a wireless remote device, and as a predictive measure rather than waiting for requests to display the assets. Transmitting the assets ahead of time rather than encoding the assets onto video frames of the application significantly reduces the computational load at the encoder and reduces video bitstream bandwidth consumed by the encoded frames. An asset refers to any image that can be used as an overlay onto a video frame. This may include permanent assets that are always present and do not move on an interactive application interface, such as a border on a word processor. Here, temporary assets are transmitted and can include both persistent and non-persistent assets. Persistent assets are temporary in the sense that the persistent assets may be displayed upon a user activation action on an interface and may remain on (e.g., visible on) the video frames until a user deactivation action is performed. Examples may include showing a button on an interactive application ribbon depressed or activated until a different button is pressed for example, or may include showing a certain ribbon when a tab is selected among a number of tabs of multiple available ribbons, and until a different ribbon is selected. By another example, a menu of commands or features may be displayed when a user clicks on a button or other activator on an interface, and then the user may remove the menu by clicking on the button again. In one alternative explained below, even characters of a font can be considered a persistent asset as well.

A non-persistent asset is an asset that only remains on or visible while the user performs a continuous action such as maintaining a mouse cursor at a certain position on the interface or over a certain object on the interface (referred to as hovering, and whether or not the user actually needs to hold the mouse or lets go of the mouse while the cursor remains on the desired position or object) or by holding down a physical mouse button, for example. Such non-persistent assets may include showing a button highlighted or depressed on the interface only while a mouse cursor hovers over the button or while both the user hovers the cursor over a button on the interface while holding down a mouse button (the physical button on a physical mouse). It will be understood that whether a button is a virtual button or other activator displayed on the interface versus a physical button on a mouse, keyboard, or other physical or mechanical activator should be clear from the context.

Once the assets are transmitted to a receiving or remote device, the assets are then composited onto video frames after the frames are decoded at the remote device and then to be displayed. To further reduce latency, the assets are transmitted to the remote device once it is known which assets are relevant to an interface that is to be displayed (or in other words, after a scene change). The system does not wait for requests for particular assets. This provides the assets stored locally at the remote device and ready for use once requested so that the system avoids just-in-time transmission of the image of the asset from the originating device. In this case, all that may be transmitted to the remote device is an event message (or just event) of asset information data that indicates the asset identification, location, and duration or frame(s) to display the asset, and other data as desired. As another technique to reduce latency, the assets may be transmitted during, and by one form only during, periods of low bandwidth consumption with the bitstream with the encoded frames of the application so that the asset transfer does not increase the actual bitrate up to a maximum capacity, thereby avoiding pauses or delays in the streaming and display of the interface.

By one form, which assets are transmitted may be prioritized based on relevancy to the interface, size of the assets, and frequency of use as well as other factors to maintain a relatively lower bandwidth consumption when transmitting the assets. The assets also may be prioritized among specific different applications when multiple interactive applications are being used (such as a word processor, a spread sheet, and a slide presentation application). In this case, the system may determine which assets to send at least partially depending on a focus duration at each application and other factors, or may be set randomly at least initially.

By one approach, when persistent assets are being used, the asset is likely to be present on a relatively large number of multiple consecutive frames (such as for at least 30 frames per second (FPS) streaming for example). In this case, a reference frame buffer at the encoder or decoder or both are updated with the transmitted assets that were actually composited. This is performed to reduce the bandwidth consumption when a user is switching back and forth among multiple windows on a screen for example. In other words, once a scene change occurs from an initial scene to a different scene (e.g., the focus changes), whether to a different interface in the same application or to an interface in a different application, the system cannot return to that initial scene interface without generating a new encoded frame since the assets were not saved on the frames. Thus, if the encoding and decoding reference frames are updated with the actually used assets, then the reference frame can be used to initiate a skip rather than encoding a new dirty frame. This can result in an extremely large savings in computational load and reduction in latency to return to the initial scene (or return the focus to the initial window).

It also should be noted that the latency referred to herein may be an input latency from a time a user performs an action on an interactive application, such as clicking on a mouse cursor to open a menu of commands, or moving a mouse cursor to a particular location to highlight a menu button for example, and to the time that the menu or highlighting is displayed on a screen of a remote device. The input latency may include (but is not the same as) a one-way or end-to-end (E2E) latency that typically refers to the duration from a time a frame is compressed and ready to be transmitted and to a compressed frame buffer (or jitter buffer) at the remote device where frames, or packets, await to be decompressed. The input latency also includes the time for the interactive application to request the indicated asset, transmit and receive an event with asset information data, encode, transmit, and decode the video frame that is to be composited with the asset, perform the composting itself, and then render and display the asset on the video frame.

With the asset transferring arrangements described herein, low latency for interactivity can be achieved by reducing latency. It is presumed that latency can be reduced from 50 to 100 ms by 80% to under 10 ms given that only the event needs to be transmitted. Thus, the system and method used herein also reduces the latency sufficient to make virtual or augmented reality imaging viable as well. Non-persistent and/or persistent assets may be transmitted, and this may include fonts where blending the transmitted assets to be merged back (or composited) with the encoded and decoded video stream can be performed without causing corruption.

In addition, the present system and method may reduce power and bandwidth in scenarios where the utilization of those assets is frequent. For instance, changing a ribbon menu would merely result in sending the event instead of encoding and transmitting a new frame which requires reading the source frame and writing back a new reconstructed frame for each frame in a video sequence involved. So the more the user toggles the ribbon, the greater the power savings.

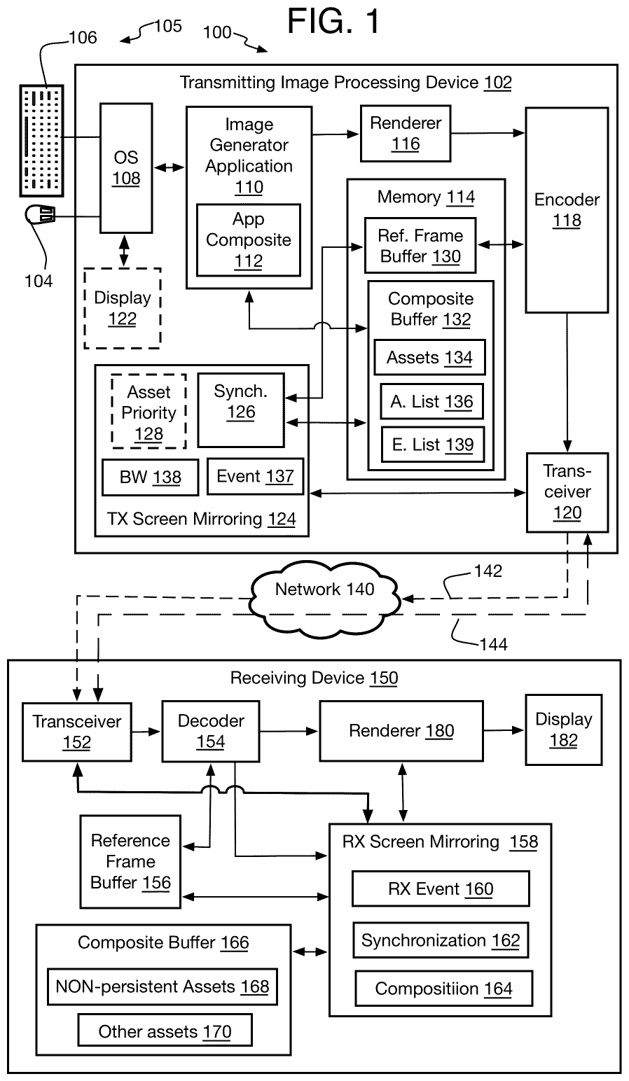

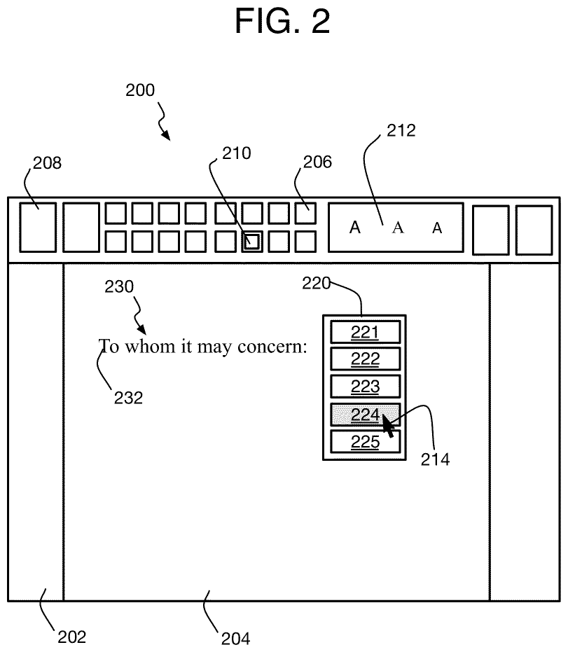

Referring to FIG. 1, an image processing system 100 operates methods disclosed herein for low latency video coding for interactive applications and may have a transmitting image processing device 102 (or transmitting side or encoder side device) communicating through a computer or communications network 140 to at least one receiving (or remote or decoder) device or side 150. The transmitting device 102 may be, or have, a computer including circuitry to operate applications and provide video sequences of interfaces for interactive applications for screen sharing or mirroring for example, and that is described in detail below with FIG. 2. The applications may be many different types as long as assets are provided as described herein and that can be overlaid on video frames of the interfaces. The network 140 may be the internet or any other wide area network (WAN), local area network (LAN), personal area network (PAN), and so forth that handles video transmissions. The receiving device 150 may be, or have, circuitry that decodes, processes, and displays images. Both the transmitting device 102 and the receiving device 150 each may be at a single physical location or may be a single device, or may be formed cooperatively among a number of devices communicating over one or more networks to form the receiving device 150. Thus, the transmitting and receiving devices 102 and 150 may be any computing device such as a smartphone, tablet, laptop, desktop, mobile gaming handheld device, or game console, but could also be a base that performs the processing for a remote display such as a virtual reality (VR) display worn by a user, and so forth. The devices 102 and 150 also may be peer devices or may be server and client, and so forth.

The image processing device 102 may include input devices 105 such as a mouse 104 and keyboard 106, an operating system (OS) 108 communicating with the input devices, an image generator application unit 110 (or just application 110) that may have an application composite unit 112, memory 114, a renderer 116, an encoder 118, a transceiver 120, optionally a display 122, and a TX screen mirroring unit 124.

The input devices 105 may be other than those shown such as a touch screen or stylus-based screen on a display 122, audio, video, tactile input device or module, or any other input device or mechanism that indicates selection of an asset of the application 110. The display 122 may be a local or integrated monitor, monitor connected by wires, or additional remote wireless monitor, and is not limited to a type of monitor or display. The OS 108 manages the communication among the input devices 105, application 110, and display 122 if provided, and may be any known OS system.

The application 110, as discussed below, may be an interactive application for work productivity, but could be a gaming application or other type of application, as long as interactive interfaces are generated by the application 110. The application 110 may have a list of assets 136 for each scene or different interface to be displayed, and may place that list 136 as well as the image data (assets 134) of the listed assets to a composite buffer 132 in a memory 114 when a scene is being used. The application 110 also may have its own composite unit 112 that receives a request for an asset by a user activation on the application interface, determines which asset was selected, and the location of the asset on the interface. The asset may be placed on an interface frame by the composite unit 112, where instructions to place the image data of the asset within the image data of a frame is generated, and then a renderer 116 may generate the composited image data for either display at display 122 for example or for encoding and transmission. The composite unit 112 may use any desired blending technique whether simply replacing the frame image data with the overlay asset image data or some other combination of the two image data sources.

Whether or not an asset is being used, the image data (or instructions for generating the image data) from the image generator application 110 may be provide to the renderer 116. The completed images are then provided to the encoder 118. It will be understood that while the present system and method are mainly used for artificial images that need rendering, the artificial frames could include or may be for camera video applications where assets are placed over a video frame for example. In this case, the rendering unit 116 also may be a camera or video pre-processing unit that provides camera images with overlaid assets to the encoder 118.

The encoder 118 may operate according to a codec standard such as MPEG-4 (H.264), HEVC (H.265), AVC, VP #, and so forth. This operation also may include any pre or post processing necessary for the coding such as color scheme conversion, scaling, de-noising and so forth. The encoder then may provide compressed frames to a transceiver (or transmitter) 120 for wireless or wired transmission. The encoder's reference frame buffer 130 may be stored in memory 114 with assets 134 in the composite buffer 132. The memory 114 may be a type of RAM, cache, or other memory. Thus, while the reserved storage space for reference frames and composite assets may be fixed (such as 80%/20%), instead the amount of storage available for the composite buffer 132 and assets 134 can be changed dynamically at least partially based on the size and amount of encoding reference frames, and the amount of data to store low latency application assets can be adjusted accordingly.

To use a wireless screen mirroring protocol, the transmitting device 102 also may have the TX screen mirroring unit 124, while a receiving unit 150 may have the corresponding RX screen mirroring unit 158 to display the interfaces remotely as described below. The TX screen mirroring unit 124 may have a number of functions to establish and maintain a mirroring channel to the remote or receiving device. This may include functions such as initialization of the mirroring unit session, establishing a connection, authentication and authorization to provide receiving devices access to the channel, and managing the screen capture, encoding, and data transmission.

With regard to the asset management, and on the transmission side, the TX screen mirroring unit 124 may manage the transmission of the asset list 136 and listed assets 134 to the receiving device, and may have, or have access to, a bandwidth or bandwidth monitoring unit 138 so that the assets can be transmitted during a time of low bandwidth consumption by the encoded video stream. The TX screen mirroring unit 124 also may have an optional asset priority unit 128 in order to further reduce the amount of assets to transmit for any one scene. This may be based on frequency of use of the assets, size of the assets, and focus of multiple applications when a user is switching between multiple applications, as well as other factors.

The TX screen mirroring unit 124 also may have an event unit 137 that receives indication of asset requests and accompanying (or parameter) data from the application 110 to generate an event to be transmitted to the receiving device to display an asset on a video frame. The TX screen mirroring unit 124 may format the event, and the generated events that are to be transmitted are placed in an event list 139 to have a record of the transmitted events.

The TX screen mirroring unit 124 also may have a synchronization unit 126 that synchronizing the reference frames of the encoder reference frame buffer 130 with the actually composited frames at the receiver. This is explained in greater detail below.

Turning to receiving device 150, it will be understood that multiple receiving devices 150 may exist each receiving transmissions from the transmitting device 102. The receiving device may have a wireless (or additionally wired) transceiver or receiver 152, decoder 154 with a decoder reference frame buffer 156, the RX screen mirroring unit 158 with an RX event unit 160, synchronization unit 162, and composition unit 164. The receiving device 150 also may have a composite buffer 166 storing both non-persistent assets and other assets including persistent assets. The receiving device 150 also may have a renderer unit 180 and a display 182.

The decoder reference frame buffer 156 and the composite buffer 166 may share a memory (not shown) as with memory 114, and may allocate portions of the memory between reference frames and assets also as explained above with memory 114.

Upon receiving the assets, the assets 168 and 170 are stored in the composite buffer 166. The transceiver 152 and decoder 154 also may receive video frames of the application interface, which may be rendered by renderer 180 and then displayed on display 182. The display 182 may be any wired or wireless display whether separate monitor, television, or other integral screen such as on a laptop, desktop, tablet, smartphone, and so forth.

The RX screen mirroring unit 158 may perform mirroring functions as with the TX screen mirroring unit 124, such as initialization, connection establishment, authorization, and so forth. Here, however, the RX event unit 160 of the screen mirroring unit 158 may receive and read events from the transceiver 152. The composition unit 164 then may obtain or indicate the asset from the composite buffer 166 and perform the composition of the asset onto a corresponding video frame according to the event data, by blending the image data of the asset onto the frame image data to include the asset. The composition alternatively may be performed by the renderer 180 itself.

The RX synchronization unit 162 may send a confirmation via transceiver 152 that the composition was performed for a particular event, and then may update a corresponding reference frame in the decoder reference buffer 156 with the asset that was composited. This may be in synchronization with the updating of the same or corresponding frame at the encoder reference buffer 130 at the transmitting device 102 in response to receiving the confirmation. It will be appreciated that system 100 is one example arrangement for composition of assets and many different arrangements than the one shown here can be used to perform the composite methods described herein.

Thus, the transceivers 120 and 152 may be handling a stream 142 via network 140 and of at least three channels from the transmitting device 102 including the assets, the encoded video frames, and the events, where each channel may define a separate packeting stream or sub-stream for internet transmissions for example and that may occupy the same bandwidth for data transmission to a receiving device 150. Thus, the asset stream may be transmitted in a different format or codec, such as JPEG, compared to that being used by the encoder. At least the composition confirmations are transmitted back on stream 144 via network 140 and from the receiving device 150 to the transmitting device. The mirroring units 124 and 156 may have many other confirmation, request, and command messages transmitted between them whether or not related to the compositing operations.

Referring to FIG. 2, an example interactive application interface 200 for a word processor is shown. The interactive application interface 200 alternatively could be for any work productivity program in addition to word processors, such as spreadsheets, slide presentation programs, graphics, drawing, and/or computer aided design (CAD) applications, database or docket interfaces, internet browsers, document display and formatting applications, and so forth. Otherwise, the interface 200 could be providing video for other applications, such as for online or cloud gaming including virtual or augmented reality, video conferencing, and/or entertainment whether tv, movies, and so forth.

For the example interactive application interface 200, the interface 200 has a border 202, a page or page surface 204 and a feature or command ribbon 206 that has feature or command buttons 208. In the illustrated example, the ribbon 206 is shown with a depressed button 210 and may be a persistent asset if the ribbon remains with this appearance until the same or different button is pressed again. Also, a mouse cursor 214 is shown hovering over a button 224 of a right-click menu 220 with command buttons 221 to 225 and that appears when a user presses a physical button on a physical mouse. In this case, the button 224 will only be highlighted while the cursor 214 hovers over the button 224. This is an example of a non-persistent asset.

Features or command activators on assets may include input controls such as checkboxes, radio buttons, dropdown lists, list boxes, buttons, toggles, text fields, date field; navigational components such as breadcrumb, slider, search field, pagination, slider, tags, icons; informational components such as tooltips, icons, progress bar, notifications, message boxes, modal windows, and containers such as an accordion, and other asset activators.

Also shown, the typed text 230 itself may have each letter 232 be a persistent asset as well. The selection of the font for the text 230 may be provided in a font area 212 of the ribbon 206. In this case, instead of encoding each pixel forming the text 230 and using the encoder for each typed character 232, a collection of characters 232 of a font of a certain font style, which may include a particular color and font size, may be sent to a receiving device. The font then may be treated as a collection of persistent assets. Each typing event could trigger a location and index corresponding to the letter or symbol, and the text events may be transmitted to the receiving device while the user is typing. The receiving device then overlays the text 230 onto frames upon receiving the text events from the transmitting device just like any other transmitted persistent asset and without being encoded. The text 230 may be overlaid on decoded video frames and function as hundreds of persistent assets, and the user should not be able to detect a difference upon viewing the interface. The next occurrence to trigger an encode may be when the page scrolls each time a user types to an end of a line and continues to a next line on the page. The text characters 232 each may be anchored on a page at a corner (left-upper corner) of a letter or bounding box around the character, but otherwise any way that is already being used by the application creating the text to display the letters. Such locations may be in the text events sent to the receiving device.

As a result, the user may have a much better experience when the assets being displayed or letters being typed on interface 200 seem to appear immediately (with low latency) upon the user manipulating an input device, such as by moving a mouse or clicking mouse buttons, or by typing on a keyboard, to initiate the display of those assets. The latency is ideally undetectable by a user.

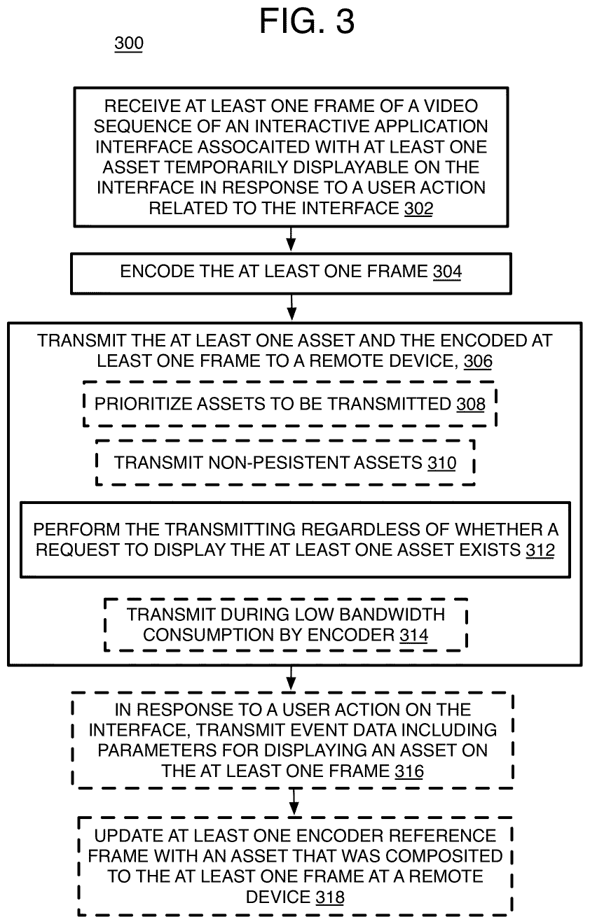

Referring to FIG. 3, an example process 300 for low latency video coding with interactive application interfaces, and for the transmitting side, is arranged in accordance with at least some implementations of the present disclosure. Process 300 may include one or more operations 302-318 numbered evenly. By way of non-limiting example, process 300 may perform coding as performed by any device, system, or unit as discussed herein such as system, device, or unit 100, 1000, 1100, and/or 1200 of FIGS. 1, 10, 11, and/or 12 respectively, and where relevant.

Process 300 may include “receive at least one frame of a video sequence of an interactive application interface associated with at least one asset temporarily displayable on the interface in response to a user action related to the interface” 302, where the interactive application is as described above. The at least one asset may be a non-persistent asset that displays on the at least one video frame only while a user performs a continuous action or maintains a cursor at a specific place on the interface. By some examples, the non-persistent asset may be a menu of available commands, or a view of a menu of available commands with at least one command activator highlighted or changed to indicate the at least one command is selected or activated. Otherwise, the at least one asset may be a persistent asset that displays on the at least one video frame in response to a first user action and may be removed from the display in response to a second user action. In addition to context menus or ribbons on an interface, the asset may be at least one character of a font, and/or all available characters of a font may be considered assets available to be transmitted. By one form, the application stores a list of all or the most commonly used assets for a particular scene or interface, such as context menus, hover overlays, fonts at different styles and sizes, and so forth.

Process 300 may include “encoding the at least one frame” 304, where a video sequence of application interfaces may be encoded as described above.

Process 300 may include “transmitting the at least one asset and the encoded at least one frame to a remote device” 306. This may involve updating a list of available assets upon indication of a scene change of the video sequence, and where removal of assets from the list may be according to an eviction policy. Thus, this operation 306 optionally may include “prioritize assets to be transmitted” 308. Such prioritizing or updating may include prioritizing multiple assets available to be transmitted for a scene depending on a probability of usage factoring at least a number of times an asset was used (or a total duration) in one or more prior interactive application interface sessions before a current scene change.

Also, the assets may be ordered by storage size, where the larger the asset, the higher the frequency of use is needed to place that asset on the asset list for transmission in order to reduce bandwidth consumption.

In addition, when a user is switching among multiple interactive application interfaces in the same application or multiple applications, the prioritization of the assets may be at least partially based on the duration of the focus on the interface or application. Otherwise, the amount of data or number of assets in the asset list may be fixed by an even or other fixed share from application to application or interface to interface, such as 50/50 in amount of data or number of assets for two applications.

Also, the eviction policy may call for complete removal of all assets from the asset list and asset buffer when a scene change occurs. By another form, the assets of the prior and new scene are compared first, and those assets that are the same on both scenes are maintained on the asset list and asset buffer, while those assets unrelated to the new scene are removed.

Operation 308 optionally may include “transmit non-persistent assets” 310, and this refers to at least non-persistent assets being transmitted in one form. By another form, both persistent and non-persistent assets (both temporary assets as explained above) may be transmitted to a receiving device.

Operation 308 may include “perform the transmitting regardless of whether a request to display the at least one asset exists” 312. Thus, this is related to the predictive nature of the asset list where the assets are transmitted before, or regardless of, the user requests for such assets are indicated on the interfaces. The assets are stored in a buffer, such as a composite buffer described above with receiving device 150 (FIG. 1).

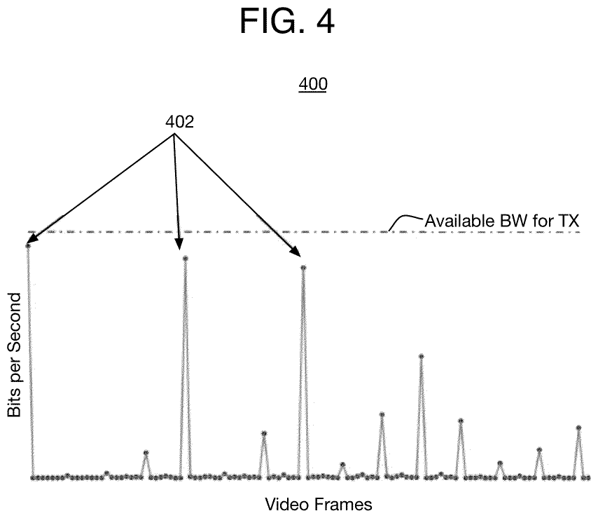

Referring to FIG. 4, operation 308 may include “transmit during low bandwidth consumption by encoder” 314. As a preliminary matter, all assets cannot typically be transmitted to a receiving device before a screen mirroring session begins and before a scene or interface is selected for display. Specifically, the session must be started first to establish the connection, such as to a dongle, for transmission of any data for the screen mirroring. Also, when a wireless mirroring session is initiated, one of the highest priorities is displaying an image with low latency so that a user or users are not waiting a relatively long time to start the screen mirroring. Waiting for a complete asset upload would take too long, and may reduce the available bandwidth too significantly such that latency of frame rendering would be too great. In addition, the wrong set of assets could be sent when a user can switch among multiple different applications, such as a word processor and a slide presentation application, thereby wasting the effort or consuming too much time to send the assets, when the assets are not used right away anyway.

Once an application has focus on a particular interface or scene, the mirroring unit can transmit assets relevant to the interface. Losing and gaining focus would be an event to adjust asset allocation for a different application. Focus here refers to which application, window (when multiple windows are present), or view is currently active on a computing device, where cursor motion, pressing on mouse buttons or a touch screen, or key strokes will affect the application in the current window, menu, or dialog box for example. Other applications are placed in the background (or can still be seen) but user interaction should not affect those background non-focused windows, and so forth.

Thus by one example, in response to having indication that an asset is to be transmitted, transmitting the asset may be initiated to occur only when a bandwidth consumption associated with a video stream from the encoding meets a criterium, which by one form is being below a threshold. Specifically, a graph 400 shows productivity work usages on an interactive application that tend to have spikes 402 of high transmission (e.g., such as while opening a new application) followed by a large number of frames of minimal to no changes (which may be static and/or skip screens).

Thus, the productivity usage tends to be described as having a very bursty transmission profile, such as a pulse signal with pulses having large variations in magnitude where periods of high change are followed by periods of little or no change. For instance, pulling up a new application will change all or most of the screen. The amount of bits then tends to stay relatively uniform and low for work productivity applications. Thus, in this example, typing in a word processor document may update every couple of frames with a minor change, and may simply encode the small changes rather than changes to entire frames.

To take advantage of this, by one form, the mirroring unit uses the periods of little or no bandwidth consumption by the encoder to transmit application related assets. These assets get transmitted and the asset list of available assets for transmission is maintained on the transmitter. As the criterium to determine whether the bandwidth consumption is sufficiently low, either the bandwidth may be monitored and then compared to a threshold bitrate to determine a period of low bandwidth consumption, or the operations being performed by the interactive application and/or encoder may be monitored and the low bandwidth consumption is simply presumed (e.g., an indication of few regions changed from dirty rectangle indication could allow the encoder to indicate a low bandwidth scenario). The mirroring unit then may provide asset data (assets or events) to the transceiver at the appropriate low bandwidth durations.

Process 300 may include “in response to a user action on the interface, transmit event data including parameters for displaying an asset on the at least one frame” 316. Thus, in response to a user action indicating a request to display a requested asset such as by moving the mouse cursor to a certain location or pressing a mouse button, the system may only transmit event data related to the requested asset to the receiving device. This may include an identification of the requested asset, a screen position of the requested asset, and/or identification of at least one frame or a duration to display the requested asset.

Optionally, process 300 may include “update at least one encoder reference frame with an asset that was composited to the at least one frame at a remote device” 318. Here, the transmitter may update at least one reference frame of the encoder by placing at least one persistent asset on the at least one reference frame in response to a confirmation that the asset was actually composited onto a frame at the receiving device. This may synchronize the encoder reference buffer with the decoder reference buffer with assets as explained herein.

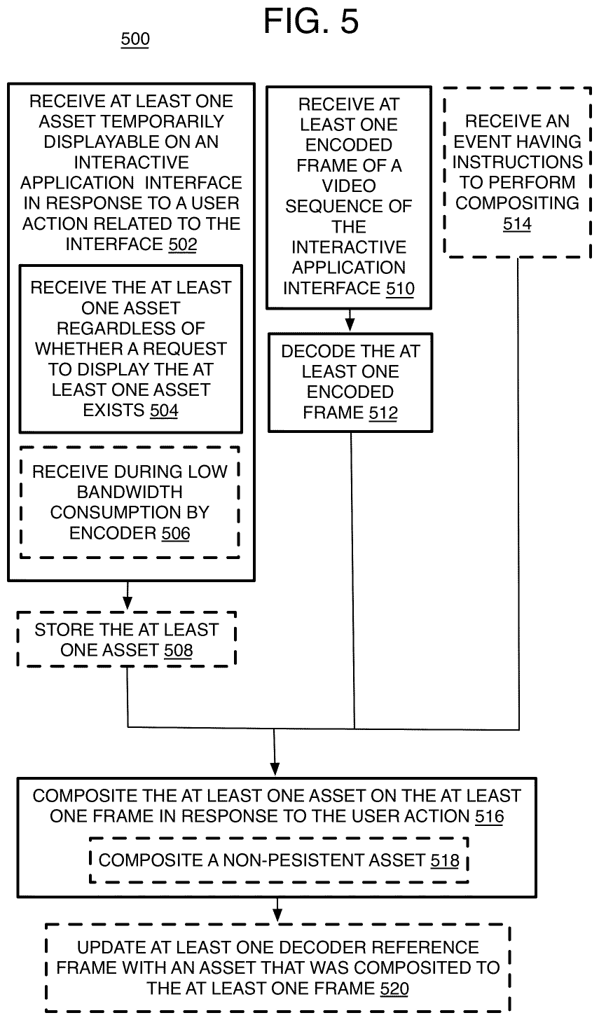

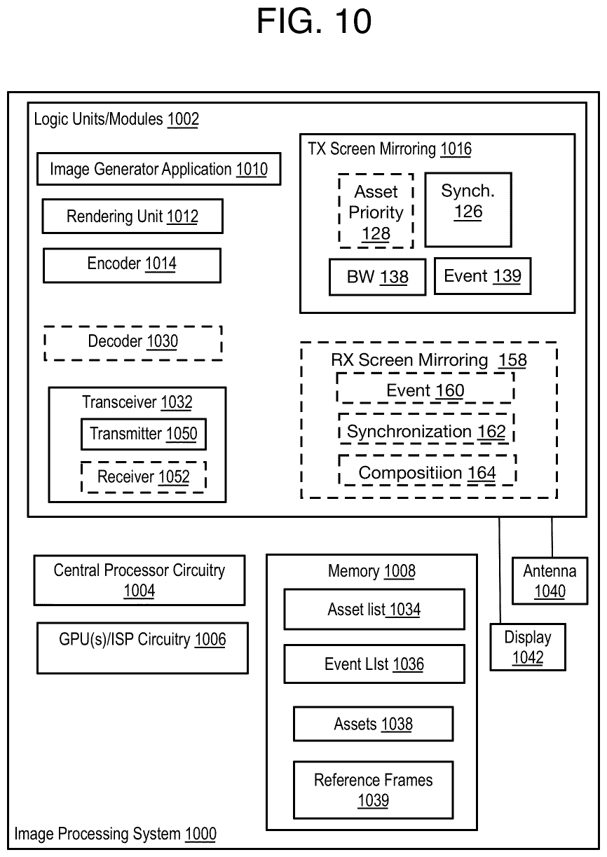

Referring to FIG. 5, an example process 500 for low latency video coding with interactive application interfaces, and for the receiving side, is arranged in accordance with at least some implementations of the present disclosure. Process 500 may include one or more operations 502-518 numbered evenly. By way of non-limiting example, process 500 may perform coding as performed by any device, system, or unit as discussed herein such as system, device, or unit 100, 1000, 1100, and/or 1200 of FIGS. 1, 10.11, and/or 12 respectively, and where relevant.

Process 500 may include “receive at least one asset temporarily displayable on an interactive application interface in response to a user action related to the interface” 502. The application and assets are described with operation 302 of process 300 above. This operation 502 also may include “receive the at least one asset regardless of whether a request to display the at least one asset exists” 504, and the predictive nature of the asset transmission is also explained above with operation 312 (FIG. 3) and system 100 (FIG. 1). Also, operation 502 optionally may include “receive during low bandwidth consumption by encoder” 506, and again, this refers to receiving the assets during low bandwidth consumption periods as explained with operation 314.

Process 500 optionally may include “store the at least one asset” 508. Here, the transmitted assets may be stored in a composite buffer, which may or may not share memory space with the decoder reference frames.

Process 500 may optionally may include “receive at least one encoded frame of a video sequence of the interactive application interface” 510, and here frames of the application interface are received, and process 500 may include “decode the at least one encoded frame” 512. The frames are then ready for compositing if needed.

Process 500 subsequently may include “receive an event having instructions to perform compositing” 514. This involves receiving events as a separate packeted stream by one example but other transmission formats or protocols could be used, such as supplemental enhancement interface (SEI) message. The events may have at least one asset ID, asset location on a screen (or frame), and asset frame(s) assignment or duration.

Process 500 may include “composite the at least one asset on the at least one frame in response to the user action” 516, and this operation 516 optionally may include “composite non-persistent assets” 518, and as mentioned above at least non-persistent assets by one example form. Here, the asset, according to the event, is composited onto the frame per the parameters in the event. The composited frame then may be rendered and displayed or stored.

Process 500 may include “update at least one decoder reference frame with an asset that was composited to the at least one frame” 520. Updating then may occur where at least one decoder reference frame is updated with the at least one asset. The updating is performed to synchronize with an act of updating of an encoder reference frame with the at least one asset. A confirmation that the compositing was performed may be transmitted back to the transmitting device, and once received, the encoder reference frame may be updated at the transmitting device.

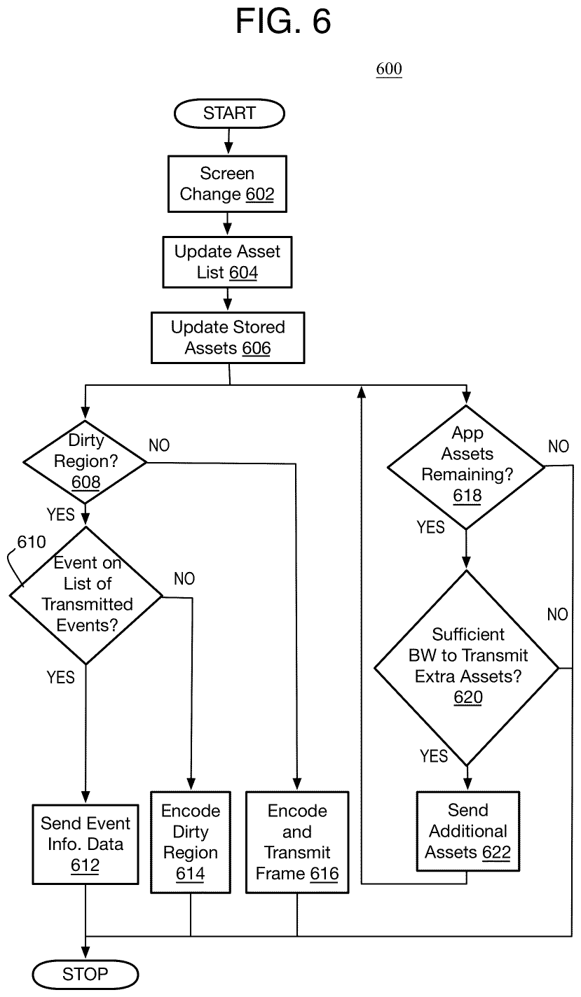

Referring to FIG. 6 for more detail, an example process 600 for low latency video coding with interactive application interfaces, and for event and asset management at the transmitting side, is arranged in accordance with at least some implementations of the present disclosure. Process 600 may include one or more operations 602-622 numbered evenly. By way of non-limiting example, process 600 may perform coding as performed by any device, system, or unit as discussed herein such as system, device, or unit 100, 1000, 1100, and/or 1200 of FIGS. 1, 10.11, and/or 12 respectively, and where relevant.

Process 600 may include “scene change” 602, where a scene change is initiated by the application or by the user, whether by opening a new application or window, or switching focus from one open window to another.

Process 600 may include “update asset list” 604. This is already described above with process 400, and may include the implementation of an eviction policy. The change of scene will trigger removal of all assets or irrelevant assets as mentioned above. The updating also may include prioritizing assets as mentioned above, and described in greater detail below with process 700.

Process 600 may include “update stored assets” 606, where the assets from the updated asset list for the new scene are stored in a composite buffer, and may be stored in a shared memory with encoder reference frames as mentioned above. Once the assets are stored, the assets may be transmitted to one or more receiving devices as described above.

Process 600 may include the inquiry “dirty region?” 608. This involves receiving a request from a user for display of an asset as described above, and where the composition data, such as ID, location, and frame of the asset is determined by the interactive application. The application or the TX mirroring unit than may compare the resulting composited data with the previous frame to determine if the asset is displayed and in the same position (or by one form, also a simple sideways or up and down scrolled position) as the last frame so that the current frame is a skip or scroll frame rather than a dirty frame. By some forms, a scroll frame may be considered a dirty frame when desired.

When the frame is to be a dirty frame, and the asset being composited is on the asset list of transmitted assets, then an event is generated and placed on the event list for transmission (or transmitted) events.

Then, when the new frame to be composited was found to be dirty (or it will be dirty), process 600 may include the inquiry “event on list of transmitted events?” 610, and therefore is relevant to an asset already provided to the receiving device. If yes, then process 600 may include “send event information data” 612 to transmit the event to the receiving device to initiate the compositing at the receiving device. If no, then even though from a dirty frame, the asset was not transmitted to the receiving device and process 600 may include “encode dirty region” 614 instead. Likewise, if the frame with the new asset is found to be a skip (or by one form, a scroll frame), then process 600 may include “encode and transmit frame” 616 instead of transmitting the event.

Regarding the transmission of the assets to the receiving device, and after the updating of the stored assets, process 600 may include the inquiry “app assets remaining?” 618, to determine if any are left to be transmitted. If yes, then process 600 may include the inquiry “sufficient bandwidth to transmit extra assets?” 620, where the bandwidth features mentioned above may be implemented such as transmitting assets, when, and by one form only when, the bandwidth consumption is low, and particularly low due to low consumption by the encoder and encoded video frames. When the bandwidth consumption is sufficiently low, such as below a threshold or presumed during certain encoder operations, process 600 may include “send additional assets” 622. If the bandwidth consumption is too high, the process stops and waits to test a different time for lower bandwidth consumption. Thereafter, the process 600 may loop back to inquiry 618 until no assets to transmit for a current scene remain and the process then stops.

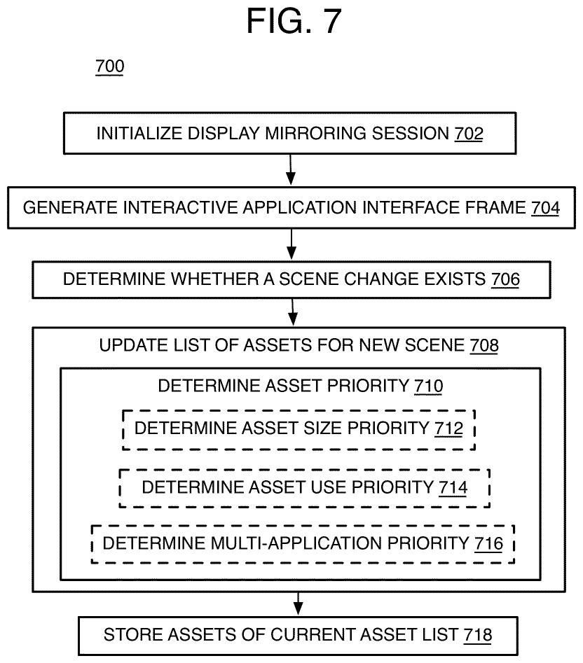

Referring to FIG. 7, an example process 700 for low latency video coding with interactive application interfaces, and with more details for the asset list management, is arranged in accordance with at least some implementations of the present disclosure. Process 700 may include one or more operations 702-718 numbered evenly. By way of non-limiting example, process 700 may perform coding as performed by any device, system, or unit as discussed herein such as system, device, or unit 100, 1000, 1100, and/or 1200 of FIGS. 1, 10, 11, and/or 12 respectively, and where relevant.

Process 700 may include “initialize display mirroring session” 702. This may occur when each transmitting device and each receiving device may open and activate a screen mirroring program and that may establish a conferencing or mirroring channel, typically accessible by an authorization code. Other functions of the mirroring program may be performed by the mirroring units as described above with system 100.

Process 700 may include “generate interactive application interface frame” 704, where the interactive application generates the interfaces either automatically, or initially automatically, and then as selected by the user at the transmitting device thereafter.

Process 700 next may include “determine whether a scene change exists” 706, which may include establishing an initial scene or interface with assets. Thereafter, the scene may change due to the interactive application generating a new scene whether automatically or by user action, switching among different interactive applications, or when focus is changed from one view to another view whether in a single application or between different applications. In any of these cases, the application generating the current window or view in focus may provide an indicator to the mirroring unit.

Process 700 may include “update list of assets for new scene” 708, and where the interactive application or the mirroring unit applies the eviction policy to remove irrelevant assets and store assets associated with the new scene. As mentioned before, it is not known if the assets are actually going to be used. The eviction policy also may include asset prioritization as described herein.

Specifically, operation 708 may include “determine asset priority” 710, and by one form, operation 710 may include “determine asset size priority” 712. Thus, by one example form, each application can prioritize a set of assets for probability of usage and relative to size. Thus, the larger the asset (in image data bytes), the greater a threshold usage frequency probability needs to be to send that asset. Thus, as a random example, a 64 byte asset may be sent with only a 20% probability of use while a 64 kilobyte asset may only be sent when the probability is greater than 50%. The thresholds for different sizes can be determined by experimentation. The asset sizes may be set by fixed size bins or simply an order of sizes among the assets to be sent. By an alternative example, the assets may be ordered by bit size or storage size alone, and the assets are transmitted from smallest to largest, or may be sent depending on the available unconsumed bandwidth while maintaining a maximum bitrate for the assets. By yet another approach, assets may be grouped together that are most likely to be used together, and then the groups may be transmitted together. Many variations or combinations of the variations may be used.

Operation 710 may include “determine asset use priority” 714, where here such prioritizing or updating may include prioritizing multiple assets available to be transmitted for a scene depending on a probability of usage factoring a number of times a same asset was used in one or more prior interactive application interface sessions with the same interface before a current scene change. This may be an accumulating total that the mirroring unit stores in a particular session, number of sessions, or certain time period, such as a day, month, or year. Instead of a number of occurrences, the frequency may factor total duration an asset is used over multiple time periods. Other ways to measure frequency of use of an asset may be based on current usage where assets are adjusted at least partly based on their activity (slide presentation application presentation versus slide editing would use different assets for example.

Operation 710 may include “determine multi-application priority” 716. Here, the application, or interface, with the longest focus compared to other applications or interfaces that are to be used may have all or more assets stored at the receiving device. Otherwise, when it is not known beforehand which of multiple applications are going to be used, and when a scene change occurs from an initial application to a different application, the assets from the previous application may be evicted relatively immediately from the asset list and stored asset buffer (within a small number of frames), or the change may occur slowly from the out of focus application until all of the desired assets of the current application have been stored and transmitted to the receiving device. By one example, if the focus returns to the initial application, the initial application cannot use the previously transmitted assets to reduce the throughput until the mirroring system has synchronized with the assets that remain stored on the receiver side.

By one form, the asset allocation may be at a fixed partition such as 50/50 or other even share for each application. Otherwise, the application or mirroring unit may allocate or partition memory dynamically (or dynamic caching) as needed. Thus, an initial application may start with 100% allocation, which is then changed to another ratio once the initial application loses focus to another application, such as to 50-50 or other ratio as deemed most appropriate by the mirroring unit or image generating application.

Process 700 may include “store assets of current asset list” 718, where the assets are stored in the composite or asset buffer as described above, and are ready to be transmitted to the receiving device as described herein.

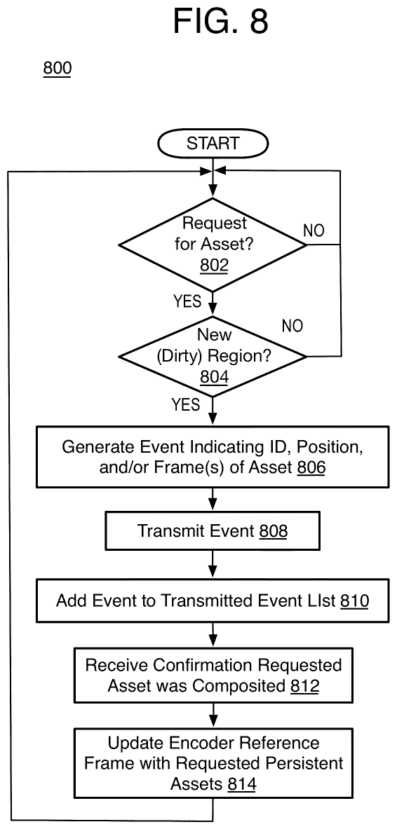

Referring to FIG. 8, an example process 800 for low latency video coding with interactive application interfaces, and for more transmitting side details of event and synchronization management, is arranged in accordance with at least some implementations of the present disclosure. Process 800 may include one or more operations 802-814 numbered evenly. By way of non-limiting example, process 800 may perform coding as performed by any device, system, or unit as discussed herein such as system, device, or unit 100, 1000, 1100, and/or 1200 of FIGS. 1, 10, 11, and/or 12 respectively, and where relevant.

Preliminarily, process 800 presumes that a scene of an application interface is set and assets from an asset list for that scene are transmitted to the receiving device for storage and later compositing upon receiving events.

Process 800 may include the inquiry “request for asset?” 802, to determine if the image generating application received an activation from a user, whether by moving a mouse cursor to a certain location on the interface, pressing mouse buttons, or performing another input device action. If no, the process loops to keep checking for the requests. When the asset is requested, the application determines the event parameters (at least the asset ID, location, and frames or duration).

Process 800 next may include the inquiry “new (dirty) region?” 804, to determine if a prior frame (or reference frame already has the same asset or event). If not, in addition to encoding and transmitting a skip frame as in operation 608 on process 600, in this case no event is sent either, and the process loops back to checking for a request for an asset as with operation 802.

If a dirty region is detected with a new asset or asset position, process 800 may include “generate event indicating ID, position, and/or frame(s) of asset” 806, where the event parameters are collected, formatted, and process 800 may include “transmit event” 808 to send the event to the receiving device. Process 800 then may include “add event to transmitted event list” 810 to keep a record of the transmission.

Process 800 may include “receive confirmation requested asset was composited” 812. The confirmation message may in the form of a confirmation code identifying the type of message and a single bit to indicate confirmation.

Upon receiving the confirmation, process 800 may include “update encoder reference frame with requested persistent assets” 814. Thus, for example, when the TX screen mirroring unit 124 receives a confirmation that an asset has been composited on a frame at the receiving device 150, that same asset is added to that same frame in the reference frame buffer 130. This avoids the need to re-encode the entire frame with the asset if the scene changes after that asset was used (where an interface window may lose focus), and the system returns to that same scene with the same asset (where the interface window regains the focus). If the composited reference frame is already saved in the reference buffers, the next change that requires encoding can use less bits by only needing skip blocks or coding units for the region that was composited. That the reference frame is synchronized through composition on the receiver and transmitter limits encoder drift from occurring.

If an error occurs and the confirmation does not arrive, an encoder then may encode the asset region of a frame with an intra block, for example, to attempt to prevent an encoding drift error.

By one form, normally it will not be worth the effort to synchronize non-persistent assets since such assets usually exist on a very short number of consecutive frames, such as 10 frames with no other changes. Thus, by one form, only persistent assets are synchronized on the encoder and decoder reference buffers.

One example exception to synchronization is a blinking asset that is on for 200 ms for example and then off for 200 ms, and may remain blinking for a relatively long period such as for minutes, or until it receives attention from a user to turn off the blinking. In this case, the blink has a particular duration of on and off. Thus, a single event transmission may provide instructions as to how many frames (or duration) should be on and then off, and repeated. The updating of the reference frames is not needed since the existence of the blinking asset will be known on each frame while the blinking is being performed without performing the large number of individual frame updates that would cause more latency.

By an alternative form, the updating and synchronizing may be omitted until a scene change or other change occurs that requires the reference frames to be updated. At that point, all asset uses from the last update to the current update are composited to the reference frames as indicated by confirmations of events received at the transmitting device. The confirmations may be omitted if the receiving side collects a record of the events and compositions, and transmits the record once an updating is required.

Regarding the font as an asset, overlaying and blending each text character each time a character is added, and then updating the reference frames to blend the text characters into the reference frames creates a large computational load. Thus, by one form to reduce the load and bandwidth consumption, the updating may be limited to only when a new text character is being composited that has not been used before in a single session. By yet another font alternative example, instead of performing the updating for each or individual typed characters, the updating of the reference frames may be delayed until a certain point such as at the end of a typing line on a page. Then encoding of a single line of text can be performed with a relatively low computational load and low bandwidth consumption.

On the other hand, changing other assets, such as a ribbon, displaying a menu, or changing an interface or application has much more bandwidth consumption to encode these changes. When these changes are updated on the reference frames, so for example having blended the ribbon into a reference picture, this would result in skip blocks for those frames during encoding (and unless something else changed the frames), and this will not significantly impact the bitrate if at all. However, if the reference frames have not been updated, then those frames need to have the assets overlaid again and the frames dirty encoded again.

By another exception to the synchronizing, when a slide presentation is to be mirrored to a remote display and is ready for display (in contrast to a slide development stage), the future and past frames showing the slides can be transmitted and stored at the receiving device before the frames are presented under the control of the transmitting device. So any toggling forward and backward as initiated at the transmitting device would not result in a need to re-transmit any of the frames to the receiving device. This permits the encoder to intentionally maintain a small encoder reference frame list to allow more slides to be sent as a media file rather than by encoding and video streaming for improved interactivity. This allows for more responsive referencing than a typical encoder. The encoder is limited to a certain number of frames in its reference frame list and if referenced, would be efficient. But once a future frame is requested that isn't reference, it would require a complete encode/transmit/receive/decode operation. Whereas, the event of progressing to the next slide could just pull that slide from the asset list and display it. Similarly, if a frame five or ten back is requested in the form of an event by a presenter jumping around in the presentation (or frames in order as they are being presented or going to be presented), the distant past (or other) frame could be stored in the buffer and be provided without requiring encoding, transmit, receive, and decoding.

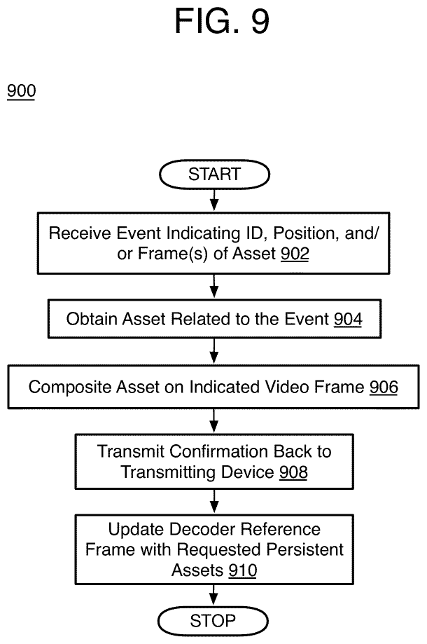

Referring to FIG. 9, an example process 900 for low latency video coding with interactive application interfaces, and for receiving side details of event and synchronization management, is arranged in accordance with at least some implementations of the present disclosure. Process 900 may include one or more operations 902-910 numbered evenly. By way of non-limiting example, process 900 may perform coding as performed by any device, system, or unit as discussed herein such as system, device, or unit 100, 1000, 1100, and/or 1200 of FIGS. 1, 10, 11, and/or 12 respectively, and where relevant.

Preliminarily, many of the details of receiving side process 900 are already described with the transmitting side process 800 and apply equally here and need not be repeated. Process 900 is provided to explain the order of the operations on the receiving side regarding event and synchronization management.

Process 900 may include “receive event indicating ID, position, and/or frame(s) of asset” 902, and as the events are described above.

Process 900 may include “obtain asset related to the event” 904, and obtained from the composite buffer at the receiving device that stores the assets already received before events were issued, or at least regardless of whether or not user requests for the assets were indicated on a frame of a current application interface.

Process 900 may include “composite asset on indicated video frame” 906, where the image data of the frame is modified to display the asset on the frame according to the parameters of the event. Once composited, the composited frame is provided to a renderer for display, and process 900 may include “transmit confirmation back to transmitting device” 908 to confirm the compositing is complete for the specific event.

The process 900 then may include “update decoder reference frame with requested persistent asset” 910, and when the asset is persistent, a corresponding decoder frame is updated with the asset by modifying the image data to display the asset in the correct location on decoder the reference frame. The receipt of the event itself may be an inherent instruction to perform the decoder side reference frame updating, but alternatively, the event may have a code, such as a bit to indicate whether updating of the decoder reference frame should be performed. This synchronizes the decoder and encoder reference frame buffers to limit encoder drift as explained above.

While implementation of the example processes 300, 500, 600, 700, 800, and 900 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Referring to FIG. 10, an example image processing system or device 1000 for video coding is arranged in accordance with at least some implementations of the present disclosure. The system 1000 may be the transmitting device (or originating image processing device (or server), receiving device, or both. Multiple systems 1000 may be present being both a transmitting and a receiving device. As shown on FIG. 10, system 1000 may include central processor circuitry 1004, and by one form with at least one GPU and/or ISP circuitry 1006, logic units or modules 1002, and a memory 1008. To be a transmitting device, the logic units 1002 may have an image generator unit 1010, a rendering unit 1012, an encoder 1014, and a TX mirroring unit 1016, a transceiver 1032. The TX screen mirroring unit 1016 has a synchronization unit 126, an optional asset priority unit 128, bandwidth monitoring unit 138, and an event unit 139. The transceiver 1032 may have a transmitter 1050 and a receiver 1052. To be a receiving device, the logic unit 1002 also may include a decoder 1030, and an RX screen mirroring unit 158 with an event unit 160, synchronization unit 162, and composition unit 164.

System 1000 also may have an antenna 1040 for transmission or reception of compressed image data and the like. A display 1042, whether local or remote, may be provided to display rendered images as mentioned herein.

The details and operation of these components to perform the disclosed methods and operate the disclosed systems as suggested by the labels of the units are described above in any of the disclosed systems or methods.

Memory 1008 may store one or more mirroring units as disclosed herein and including an asset list buffer 1034, an event list buffer 1036, and an asset buffer 1038, as well as a coding reference frame buffer 1039. Memory 1008 may be one or more separate or partitioned memories and any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory 1008 may be implemented by cache memory.

Processor circuitry 1004 and 1006 may include any number and type of central, video, rendering, encoding, image, or graphics processing units that may provide the processors to perform the operations as discussed herein. Processor circuitry 1004 and 1006 may provide firmware or hardware, and operate software, or any combination thereof, and may have programmable logic or circuitry such as a logic core or cores that may provide a wide array of programmable logic functions. In an implementation, processor(s) may include dedicated hardware such as fixed function circuitry. Fixed function circuitry may include dedicated logic or circuitry and may provide a set of fixed function entry points that may map to the dedicated logic for a fixed purpose or function.

Various components of the systems described herein may be implemented in software, firmware, and/or hardware and/or any combination thereof. For example, various components of the systems or devices discussed herein may be provided, at least in part, by hardware of a computing System-on-a-Chip (SoC) such as may be found in a computing system such as, for example, a smart phone. Those skilled in the art may recognize that systems described herein may include additional components that have not been depicted in the corresponding figures. For example, the systems discussed herein may include additional components such as bitstream multiplexer or de-multiplexer modules and the like that have not been depicted in the interest of clarity.

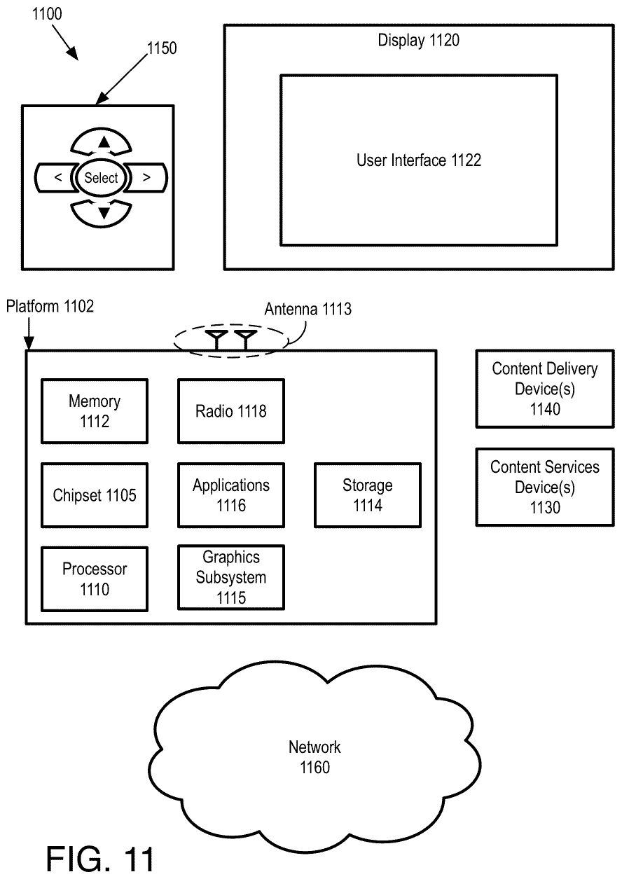

Referring to FIG. 11, an example system 1100 is arranged in accordance with at least some implementations of the present disclosure, and may be system 100 or 1000 or may operate any of processes 300, 500, 600, 700, 800, or 900, described above. In various implementations, system 1100 may be, or have, a server, cloud server, internet server, networked computer, or networked computing device. By other implementations, system 1100 may be, or have, a mobile system. For example, either the transmitting or receiving side or both of system 1100 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras, and so forth.

In various implementations, system 1100 includes a platform 1102 coupled to a display 1120. Platform 1102 may receive content from a content device such as content services device(s) 1130 or content delivery device(s) 1140 or other similar content sources. A navigation controller 1150 including one or more navigation features may be used to interact with, for example, platform 1102 and/or display 1120. Each of these components is described in greater detail below.

In various implementations, platform 1102 may include any combination of a chipset 1105, processor 1110, memory 1112, antenna 1113, storage 1114, graphics subsystem 1115, applications 1116 and/or radio 1118. Chipset 1105 may provide intercommunication among processor 1110, memory 1112, storage 1114, graphics subsystem 1115, applications 1116 and/or radio 1118. For example, chipset 1105 may include a storage adapter (not depicted) capable of providing intercommunication with storage 1114.

Processor 1110 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1110 may be dual-core processor(s), dual-core mobile processor(s), and so forth.

Memory 1112 may be implemented as a volatile memory device such as, but not limited to, a Random Access Memory (RAM), Dynamic Random Access Memory (DRAM), or Static RAM (SRAM).

Storage 1114 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1114 may include technology to increase the storage performance enhanced protection for valuable digital media when multiple hard drives are included, for example.

Graphics subsystem 1115 may perform processing of images such as still or video for display. Graphics subsystem 1115 may be a graphics processing unit (GPU) or a visual processing unit (VPU), for example. An analog or digital interface may be used to communicatively couple graphics subsystem 1115 and display 1120. For example, the interface may be any of a High-Definition Multimedia Interface, DisplayPort, wireless HDMI, and/or wireless HD compliant techniques. Graphics subsystem 1115 may be integrated into processor 1110 or chipset 1105. In some implementations, graphics subsystem 1115 may be a stand-alone device communicatively coupled to chipset 1105.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1118 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1118 may operate in accordance with one or more applicable standards in any version.

In various implementations, display 1120 may include any television type monitor or display. Display 1120 may include, for example, a computer display screen, touch screen display, video monitor, television-like device, and/or a television. Display 1120 may be digital and/or analog. In various implementations, display 1120 may be a holographic display. Also, display 1120 may be a transparent surface that may receive a visual projection. Such projections may convey various forms of information, images, and/or objects. For example, such projections may be a visual overlay for a mobile augmented reality (MAR) application. Under the control of one or more software applications 1116, platform 1102 may display user interface 1122 on display 1120.

In various implementations, content services device(s) 1130 may be hosted by any national, international and/or independent service and thus accessible to platform 1102 via the Internet, for example. Content services device(s) 1130 may be coupled to platform 1102 and/or to display 1120. Platform 1102 and/or content services device(s) 1130 may be coupled to a network 1160 to communicate (e.g., send and/or receive) media information to and from network 1160. Content delivery device(s) 1140 also may be coupled to platform 1102 and/or to display 1120.

In various implementations, content services device(s) 1130 may include a cable television box, personal computer, network, telephone, Internet enabled devices or appliance capable of delivering digital information and/or content, and any other similar device capable of uni-directionally or bi-directionally communicating content between content providers and platform 1102 and/display 1120, via network 1160 or directly. It will be appreciated that the content may be communicated uni-directionally and/or bi-directionally to and from any one of the components in system 1100 and a content provider via network 1160. Examples of content may include any media information including, for example, video, music, medical and gaming information, and so forth.

Content services device(s) 1130 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1102 may receive control signals from navigation controller 1150 having one or more navigation features. The navigation features of may be used to interact with user interface 1122, for example. In various implementations, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1120) by movements of a pointer, cursor, focus ring, or other visual indicators displayed on the display. For example, under the control of software applications 1116, the navigation features located on navigation may be mapped to virtual navigation features displayed on user interface 1122, for example. In various implementations, may not be a separate component but may be integrated into platform 1102 and/or display 1120. The present disclosure, however, is not limited to the elements or in the context shown or described herein.

In various implementations, drivers (not shown) may include technology to enable users to instantly turn on and off platform 1102 like a television with the touch of a button after initial boot-up, when enabled, for example. Program logic may allow platform 1102 to stream content to media adaptors or other content services device(s) 1130 or content delivery device(s) 1140 even when the platform is turned “off.” In addition, chipset 1105 may include hardware and/or software support for 5.1 surround sound audio and/or high definition 11.1 surround sound audio, for example. Drivers may include a graphics driver for integrated graphics platforms. In various implementations, the graphics driver may include a peripheral component interconnect (PCI) Express graphics card.

In various implementations, any one or more of the components shown in system 1100 may be integrated. For example, platform 1102 and content services device(s) 1130 may be integrated, or platform 1102 and content delivery device(s) 1140 may be integrated, or platform 1102, content services device(s) 1130, and content delivery device(s) 1140 may be integrated, for example. In various implementations, platform 1102 and display 1120 may be an integrated unit. Display 1120 and content service device(s) 1130 may be integrated, or display 1120 and content delivery device(s) 1140 may be integrated, for example. These examples are not meant to limit the present disclosure.

In various implementations, system 1100 may be implemented as a wireless system, a wired system, or a combination of both. When implemented as a wireless system, system 1100 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1100 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1102 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words that are provided for an automated system. For example, control information may be used to route media information through a system, or instruct a node to process the media information in a predetermined manner. The implementations, however, are not limited to the elements or in the context shown or described in FIG. 11.

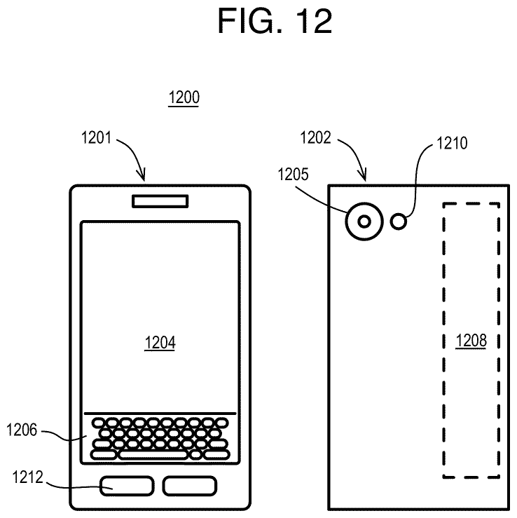

As described above, system 1000 or 1100 may be embodied in varying physical styles or form factors. FIG. 12 illustrates an example small form factor device 1200, arranged in accordance with at least some implementations of the present disclosure. In some examples, system 1000 or 1100 may be implemented via device 1200. In other examples, system 100, interface 200, or portions thereof may be implemented via device 1200. In various implementations, device 1200 may be implemented as a networked computer and/or mobile computing device having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computer, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 12, device 1200 may include a housing with a front 1201 and a back 1202. Device 1200 includes a display 1204, an input/output (I/O) device 1206, and an integrated antenna 1208. Device 1200 also may include navigation features 1212. I/O device 1206 may include any suitable I/O device for entering information into a mobile computing device. Examples for I/O device 1206 may include an alphanumeric keyboard, a numeric keypad, a touch pad, input keys, buttons, switches, microphones, speakers, voice recognition device and software, and so forth. Information also may be entered into device 1200 by way of microphone (not shown), or may be digitized by a voice recognition device. As shown, device 1200 may include one or more cameras 1205 (e.g., including a lens, an aperture, and an imaging sensor) and a flash 1210 integrated into back 1202 (or elsewhere) of device 1200. In other examples, camera 1205 and flash 1210 may be integrated into front 1201 of device 1200 or both front and back cameras may be provided. Camera 1205 and flash 1210 may be components of a camera module to originate image data processed into streaming video that is output to display 1204 and/or communicated remotely from device 1200 via antenna 1208 for example.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores, may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By an example 1, a computer-implemented method of video coding comprises receiving at least one frame of a video sequence of an interactive application interface associated with at least one asset displayable on the interface in response to a user action related to the interface; encoding the at least one frame; and transmitting the at least one asset and the encoded at least one frame to a remote device, and performing the transmitting regardless of whether a request to display the at least one asset exists.

By an example 2, the subject matter of example 1, wherein the at least one asset is a non-persistent asset that displays on the at least one frame only while a user performs a continuous action or maintains a cursor at a specific place on the interface.

By an example 3, the subject matter of example 2, wherein the non-persistent asset is at least one of: a menu of available commands, or a view of a menu of available commands with at least one command activator highlighted or changed to indicate at least one of the commands is selected or activated.

By an example 4, the subject matter of any one of examples 1-3, wherein the at least one asset is a persistent asset that displays on the at least one frame in response to a first user action and is removed from the display in response to a second user action.

By an example 5, the subject matter of any one of examples 1-4, wherein the method comprises prioritizing multiple assets of the at least one asset to be transmitted depending on a probability of usage factoring at least a number of times an asset was used in one or more prior interactive application interface sessions with a first scene before a current scene change to the first scene.

By an example 6, the subject matter of any one of examples 1-5, the method comprises comprising updating at least one reference frame of the encoding by placing the at least one asset on the at least one reference frame in response to the at least one asset being displayed on a transmitted at least one frame on a remote device.

By an example 7, the subject matter of any one of examples 1-6, the method comprises updating a list of available assets upon indication of a scene change of the video sequence; and transmitting the assets on the list regardless of whether a request for any of the assets already exists.

By an example 8, the subject matter of any one of examples 1-7, wherein the method comprises in response to having indication that the at least one asset is to be transmitted, transmitting the at least one asset only when a bandwidth consumption associated with a video stream meets a criterium.

By an example 9, the subject matter of example 8, wherein the method comprises in response to a user action indicating a request to display a requested asset, only transmitting event data elated to the requested asset and providing at least one of: an identification of the requested asset, a screen position of the requested asset, and identification of at least one frame or a duration to display the requested asset.

By an example 10, the subject matter of any one of examples 1-9, wherein the method comprises decoding the at least one frame and compositing, in response to the user action, the at least one asset on the at least one frame at a remote device.

By an example 11, at least one non-transitory article with at least one machine readable medium comprising a plurality of instructions that, in response to being executed on a computing device, cause the computing device to operate by: receiving at least one encoded frame of a video sequence of an interactive application interface and at least one asset displayable on the interface in response to a user action related to the interface, wherein the least one asset is received regardless of whether a request to display the at least one asset exists; decoding the at least one encoded frame; and compositing the at least one asset on the at least one frame and in response to the user action.

By an example 12, the subject matter of example 11, wherein the instructions are arranged to cause the computing device to operate by receiving events of persistent or non-persistent displayable assets with at least one asset ID, asset location, and asset frame(s) assignment or duration; and performing the compositing according to the event.

By an example 13, the subject matter of example 11 or 12, wherein the instructions are arranged to cause the computing device to operate by transmitting a confirmation back to a transmitting device that the compositing was performed.

By an example 14, the subject matter of any one of examples 11-13, wherein the instructions are arranged to cause the computing device to operate by updating at least one decoder reference frame with the at least one asset.

By an example 15, the subject matter of any one of examples 11-14, wherein the updating is performed to synchronize with an act of updating of an encoder reference frame with the at least one asset.

By an example 16, a computer-implemented system comprises memory to store a list of persistent or non-persistent assets associated with video frames of an interactive application interface; and processor circuitry communicatively coupled to the memory and being arranged to operate by: transmitting at least one of the assets to a receiving device, and comprising performing the transmitting regardless of whether a user action already indicates a request to display the at least one asset, and transmitting encoded video frames associated with the at least one asset to the receiving device to composite the video frames with the assets at the receiving device.

By an example 17, the subject matter of example 16, wherein the processor circuitry is arranged to operate by providing assets of multiple interactive application interfaces, and wherein the processor circuitry is arranged to operate by prioritizing assets to be placed on a list of assets to transmit at least partially depending on focus durations of the interfaces.

By an example 18, the subject matter of example 16 or 17, wherein the processor circuitry is arranged to operate by prioritizing assets to be placed on a list of assets to transmit at least partially depending on a storage size of the assets.

By an example 19, the subject matter of any one of examples 16-18, wherein the processor circuitry is arranged to operate by updating a list of available assets upon indication of a scene change to a scene of the video frames, and including removing assets from the list that are unrelated to the scene and adding assets to the list that are related to the scene.

By an example 20, the subject matter of any one of examples 16-19, wherein the at least one asset is at least one character of a font.

In one or more implementations, a device, apparatus, or system includes means to perform a method according to any one of the above implementations.

In one or more implementations, at least one machine readable medium includes a plurality of instructions that in response to being executed on a computing device, cause the computing device to perform a method according to any one of the above implementations.

It will be recognized that the implementations are not limited to the implementations so described, but can be practiced with modification and alteration without departing from the scope of the appended claims. For example, the above implementations may include specific combination of features. However, the above implementations are not limited in this regard and, in various implementations, the above implementations may include the undertaking only a subset of such features, undertaking a different order of such features, undertaking a different combination of such features, and/or undertaking additional features than those features explicitly listed. The scope of the implementations should, therefore, be determined with reference to the appended claims, along with the full scope of equivalents to which such claims are entitled.

What is claimed is:

1. A computer-implemented method of video coding comprising:
receiving at least one frame of a video sequence of an interactive application interface associated with at least one asset displayable on the interface in response to a user action related to the interface;
encoding the at least one frame; and
transmitting the at least one asset and the encoded at least one frame to a remote device, and performing the transmitting regardless of whether a request to display the at least one asset exists.

2. The method of claim 1, wherein the at least one asset is a non-persistent asset that displays on the at least one frame only while a user performs a continuous action or maintains a cursor at a specific place on the interface.

3. The method of claim 2, wherein the non-persistent asset is at least one of: a menu of available commands, or a view of a menu of available commands with at least one command activator highlighted or changed to indicate at least one of the commands is selected or activated.

4. The method of claim 1, wherein the at least one asset is a persistent asset that displays on the at least one frame in response to a first user action and is removed from the display in response to a second user action.

5. The method of claim 1, comprising prioritizing multiple assets of the at least one asset to be transmitted depending on a probability of usage factoring at least a number of times an asset was used in one or more prior interactive application interface sessions with a first scene before a current scene change to the first scene.

6. The method of claim 1, comprising updating at least one reference frame of the encoding by placing the at least one asset on the at least one reference frame in response to the at least one asset being displayed on a transmitted at least one frame on a remote device.

7. The method of claim 1, comprising updating a list of available assets upon indication of a scene change of the video sequence; and transmitting the assets on the list regardless of whether a request for any of the assets already exists.

8. The method of claim 1, comprising, in response to having indication that the at least one asset is to be transmitted, transmitting the at least one asset only when a bandwidth consumption associated with a video stream from the encoding is below a threshold.

9. The method of claim 8, comprising, in response to a user action indicating a request to display a requested asset, only transmitting event data elated to the requested asset and providing at least one of: an identification of the requested asset, a screen position of the requested asset, and identification of at least one frame or a duration to display the requested asset.

10. The method of claim 1, comprising decoding the at least one frame and compositing, in response to the user action, the at least one asset on the at least one frame at a remote device.

11. At least one non-transitory article with at least one machine readable medium comprising a plurality of instructions that, in response to being executed on a computing device, cause the computing device to operate by:
receiving at least one encoded frame of a video sequence of an interactive application interface and at least one asset displayable on the interface in response to a user action related to the interface, wherein the least one asset is received regardless of whether a request to display the at least one asset exists;
decoding the at least one encoded frame; and
compositing the at least one asset on the at least one frame and in response to the user action.

12. The article of claim 11, wherein the instructions are arranged to cause the computing device to operate by receiving events of persistent or non-persistent displayable assets with at least one asset ID, asset location, and asset frame(s) assignment or duration; and performing the compositing according to the event.

13. The article of claim 11, wherein the instructions are arranged to cause the computing device to operate by transmitting a confirmation back to a transmitting device that the compositing was performed.

14. The article of claim 11, wherein the instructions are arranged to cause the computing device to operate by updating at least one decoder reference frame with the at least one asset.

15. The article of claim 14, wherein the updating is performed to synchronize with an act of updating of an encoder reference frame with the at least one asset.

16. A computer-implemented system comprising:
memory to store a list of persistent or non-persistent assets associated with video frames of an interactive application interface; and
processor circuitry communicatively coupled to the memory and being arranged to operate by:
transmitting at least one of the assets to a receiving device, and comprising performing the transmitting regardless of whether a user action already indicates a request to display the at least one asset, and
transmitting encoded video frames associated with the at least one asset to the receiving device to composite the video frames with the assets at the receiving device.

17. The system of claim 16, wherein the processor circuitry is arranged to operate by providing assets of multiple interactive application interfaces, and wherein the processor circuitry is arranged to operate by prioritizing assets to be placed on a list of assets to transmit at least partially depending on focus durations of the interfaces.

18. The system of claim 16, wherein the processor circuitry is arranged to operate by prioritizing assets to be placed on a list of assets to transmit at least partially depending on a storage size of the assets.

19. The system of claim 16, wherein the processor circuitry is arranged to operate by updating a list of available assets upon indication of a scene change to a scene of the video frames, and including removing assets from the list that are unrelated to the scene and adding assets to the list that are related to the scene.

20. The system of claim 16, wherein the at least one asset is at least one character of a font.
